(19) United States
(12) Patent Application Publication
(10) Pub. No.: US 2026/0003503 A1
(43) Pub. Date: Jan. 1, 2026

(54) LOW LATENCY PARTITION FOR MEMORY SWAP OPERATIONS

(71) Applicant: Micron Technology, Inc., Boise, ID (US)

(72) Inventors: Luca Porzio, Casalnuovo (IT); Dionisio Minopoli, Frattamaggiore (IT)

(21) Appl. No.: 19/243,671

(22) Filed: Jun. 19, 2025

Related U.S. Application Data
(60) Provisional application No. 63/665,999, filed on Jun. 28, 2024.

(51) Int. Cl. G06F 3/06

(52) U.S. Cl. CPC G06F 3/061; G06F 3/0659; G06F 3/0673

(57) ABSTRACT

Methods, systems, and devices for a low latency partition for memory swap operations are described. A memory system may store swap data in a swap partition within non-volatile memory, which may effectively extend a volatile memory of the memory system, and may include a plurality of sub-partitions dedicated to storing the swap data. The memory system may detect and prioritize swap traffic that may write to or read from a swap partition. Each sub-partition may correspond to a pointer of a plurality of pointers, where each pointer indicates a mapping between the corresponding sub-partition and associated data. The memory system may operate the swap partitions according to one or more descriptors.

### CROSS REFERENCE

The present application for patent claims priority to U.S. Patent Application No. 63/665,999 by Porzio et al., entitled “LOW LATENCY PARTITION FOR MEMORY SWAP OPERATIONS,” filed Jun. 28, 2024, which is assigned to the assignee hereof, and which is expressly incorporated by reference in its entirety herein.

### TECHNICAL FIELD

The following relates to one or more systems for memory, including a low latency partition for memory swap operations.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports a low latency partition for memory swap operations in accordance with examples as disclosed herein.

FIG. 2 shows an example of a flowchart that supports a low latency partition for memory swap operations in accordance with examples as disclosed herein.

FIG. 3 shows a block diagram of a memory system that supports a low latency partition for memory swap operations in accordance with examples as disclosed herein.

FIG. 4 shows a flowchart illustrating a method or methods that support a low latency partition for memory swap operations in accordance with examples as disclosed herein.

### DETAILED DESCRIPTION

A host system may run multiple applications using one or more random access memory (RAM) (e.g., dynamic RAM (DRAM)) devices and, if application pressure on a RAM allocation meets a threshold, may determine to deactivate (e.g., stop, shut down) one or more applications that are less active (e.g., “unused” by a user) to free up volatile memory. Some host systems may support system swap operations (e.g., memory paging) to extend RAM capabilities. For example, in place of deactivating applications, a host system may temporarily store application data to another storage area, where such a storage area may be referred to as a swap area and such data may be referred to as swap data. In some examples, the application data may be temporarily stored to a non-volatile memory device, such as in not-and (NAND) memory. If application pressure is relieved, or a process is to be active at a later time, the data (e.g., swapped data) may be restored to RAM memory devices. Although system swap operations may be supported by some systems, system swap operations may lack further definition and may present opportunities for new methods to improve performance.

According to techniques described herein, a memory system may include one or more swap partitions (e.g., partitions dedicated to swap operations) within (e.g., spread across) one or more logical units (LUNs) of the memory system, where the memory system may prioritize swap traffic (e.g., a type of data or operation associated with a swap partition) over other types of traffic. In some cases, data associated with a swap partition (which may be referred to, for example, as swap data or swap traffic) may be subject to one or more operating thresholds, such as a low error threshold, a low read latency threshold, or a high throughput threshold, to maintain high performance at the memory system. However, one or more operations of the memory array (e.g., logical-to-physical (L2P) mapping operations, data protection operations, other operations associated with accessing the swapped data) may increase latency associated with swap operations, hindering the utility of the swap operations.

The memory system may detect swap traffic according to whether the traffic is written to or read from a swap partition. For example, a swap partition may be associated with a plurality of logical addresses (e.g., logical block addresses (LBAs)) organized into sub-partitions designated for storing data associated with swap operations (e.g., swap traffic). The swap traffic may indicate one or more LBAs within a swap partition. The memory system may also maintain one or more tables (or other data structures) including multiple pointers for the one or more swap partitions. Each sub-partition of each swap partition may correspond to a pointer, with each pointer indicating a mapping between the corresponding sub-partition and associated data (e.g., swap data). In some cases, the memory system may manage (e.g., handle, operate) the swap partitions according to one or more descriptors that may be indicated to a host system. For example, the descriptors may indicate the memory system's capability to support the swap partitions, a threshold size of one or more swap partitions, a size for each sub-partition, one or more LUNs of the memory system that include the one or more swap partitions, a first LBA associated with one or more swap partitions, and a last LBA associated with one or more swap partitions.

In addition to applicability in memory systems as described herein, techniques for a low latency partition for memory swap operations may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by allowing a memory system to prioritize swap traffic and avoid operations associated with storing data in non-volatile memory when performing swap operations, which may decrease a latency of performing swap operations between RAM (e.g., volatile) and NAND (e.g., non-volatile) memory and improve overall performance of the memory system, among other potential benefits.

Features of the disclosure are illustrated and described in the context of systems, devices, and circuits. Features of the disclosure are further illustrated and described in the context of processes and flowcharts.

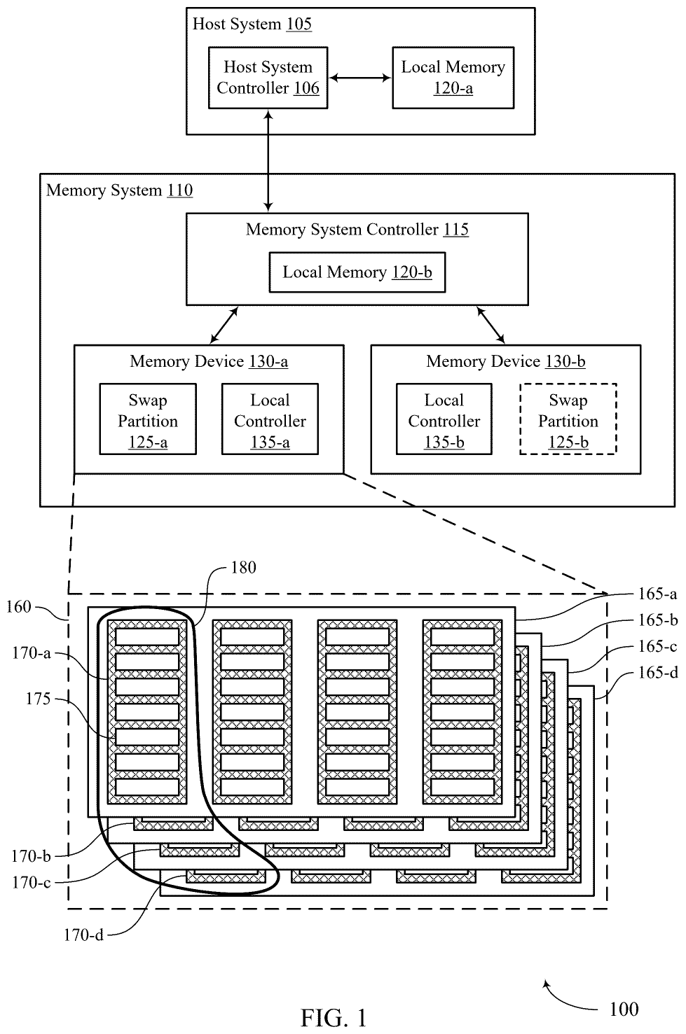

FIG. 1 shows an example of a system 100 that supports a low latency partition for memory swap operations in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between LBAs associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The system 100 may include one or more local memories 120, which may be examples of cache memory, or RAM (e.g., static RAM (SRAM), dynamic RAM (DRAM)). For example, the host system 105 may include a local memory 120-a, the memory system controller 115 may also include a local memory 120-b, or both. In some cases, a local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 (e.g., or the host system 105) for internal storage or calculations, for example, related to the functions ascribed herein to the memory system controller 115. Additionally, or alternatively, the local memory 120 may serve as a cache for the memory system controller 115, the host system 105, or both. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid LBA, such as a LBA referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as memory swap operations, wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

Additionally, or alternatively, the memory system 110 (e.g., the memory system controller 115) may perform one or more data management procedures associated with writing data to the memory devices 130 (e.g., NAND devices, non-volatile memory). For example, the one or more data management procedures may include one or more changelog management procedures (e.g., checkpoint management procedures) which the memory system controller 115 may initiate in response to receiving a write command for a memory device 130. For example, as part of the changelog management procedures, the memory system controller 115 may keep track of data to be written to the memory device 130, LBAs associate with the data, or other changes to be made in response to the write command. The memory system controller 115 may then perform the actions indicated by the changelog management procedure at a time that does not add latency to other operations of the memory system 110 (e.g., low command throughput period, low power mode duration, idle duration).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (mNAND) system.

Some memory systems (e.g., such as the memory system 110) may perform one or more swap operations associated with data from one or more of the local memories 120. A swap operation may include transferring data (e.g., swap data) from a local memory 120 (e.g., a cache memory, RAM, SRAM, DRAM) to a location within a memory device 130 for temporary storage until the data is requested by an operation of the memory system 110. For example, the memory system 110 may swap data from the local memory 120 that is inactive (e.g., has not been read or written for a threshold duration) or relatively less important (e.g., with respect to other prioritized data in the local memory 120). In some cases, performing swap operations may allow the system 100 to continue operating (e.g., even when the local memory 120 is full) by moving the data from the local memory 120 to a swap space, effectively extending the local memory 120. As a local memory 120 may be subject to different operating thresholds than a memory device 130 (e.g., reduced error mitigation thresholds, a lack of power loss recovery thresholds, lower read latency thresholds, higher read and write throughput thresholds), data associated with the swap operations (e.g., swap data, swap memory) in a memory device 130 may be subject to the different operating thresholds. However, operations of the memory devices 130 may hinder the swap data from satisfying the different operating thresholds, which may cause latency and reduced performance when accessing the swap data.

Swap data stored in a memory device 130 may incur relatively high (e.g., relative to the local memory 120) read and write latency in the swap space, as well as a relatively low write throughput. In some cases, such negative effects may be due to swap operations being a same priority as other commands (e.g., for non-swap operations) at the memory device 130, the memory system 110 performing L2P table operations (e.g., or other data management schemes) on the swap data prior to storing the swap data in the memory devices 130, or other factors. Additionally, a performance of the swap operations may be dependent of a status of the memory device 130 (e.g., busy with other operations, in a low power mode) instead of a status of the local memory 120, which may cause negative effects on the swap operations.

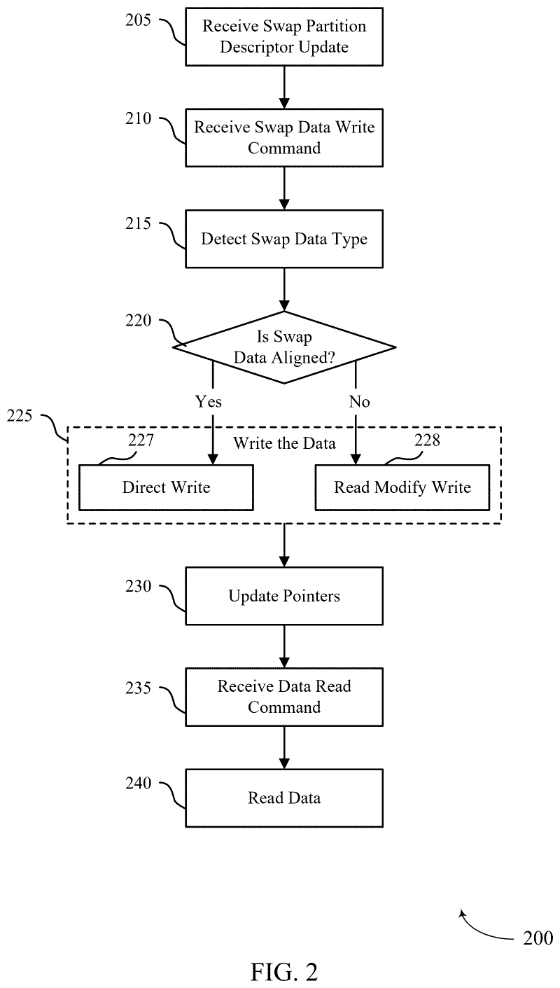

Accordingly, the techniques described herein may include determining swap traffic from amongst a plurality of operations at a memory device 130, allocating a swap partition within the memory device 130 dedicated to swap traffic, and reducing read latency while increasing write throughput associated with the swap partition. For example, the memory system 110 may include one or more swap partitions 125 (e.g., a swap partition 125-a, a swap partition 125-b) each located within one or more of the memory devices 130. In some cases, each swap partition 125 may include one or more partitions of one or more LUNs (e.g., one or more LUN partitions, a dedicated LUN partition, a set of LBAs within one or more LUNs of the memory system 110) of the memory system 110, where each swap partition may be associated with fast prioritized access (e.g., with respect to other partitions of the memory system 110) for swap traffic. A LUN may be an identifier (e.g., a unique identifier) that the memory system 110 may use for designating an individual or collection of physical or virtual addresses that execute one or more operations with the host system 105 Additionally, or alternatively, the memory system 110 may maintain one or more tables of a plurality of pointers (e.g., a management scheme, as described herein with respect to FIG. 2) to support swap traffic and the swap partitions 125. In some cases, the memory system 110 may include one or more virtual systems, where each virtual system may be associated with one or more respective swap partitions 125 and one or more respective tables of pointers associated with the one or more respective swap partitions 125.

The system 100 may include any quantity of non-transitory computer readable media that support a low latency partition for memory swap operations. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

FIG. 2 shows an example of a flowchart 200 that supports a low latency partition for memory swap operations in accordance with examples as disclosed herein. In some cases, aspects of the flowchart 200 may implement or be implemented by aspects of FIG. 1. For example, the flowchart 200 may be performed by a memory system 110 (e.g., a UFS device), which an example of the memory system 110 as described herein with respect to FIG. 1. For example, the memory system 110 may include the one or more swap partitions 125 described herein with respect to FIG. 1, as well as one or more other components or configurations for implementing a low latency partition for memory swap operations. In some aspects, the flowchart 200 may illustrate techniques for implementing the low latency swap partition in the memory system 110, which may allow for decreased latency associated with swap operations and increased throughput for swap write operations.

To implement the low latency swap partitions as described herein (e.g., such as the swap partitions 125 as described with respect to FIG. 1), the memory system 110 may provide one or more descriptors (e.g., including descriptors, flags, attributes, variables, parameters, or any combination thereof) to a host system 105, where the descriptors may be associated with an interface for swap functionality. For example, a controller of the memory system 110 (e.g., the host system 105, a memory system controller 115, a local controller 135) may use the one or more descriptors to implement swap operations, and the memory system 110 may indicate the one or more descriptors to the host system 105. For example, some descriptors may be indicated in the Table 1.

TABLE 1

| Name | Information Type | Read/Write |
|---|---|---|
| fSwapCapable | Flag | Read only |
| qSwapMaxSize | Attribute | Read only |
| bSwapChunkSize | Attribute | Read only |
| bSwapLU | Descriptor | Read and write |
| qSwapStartLba | Descriptor | Read and write |
| qSwapEndLba | Descriptor | Read and write |

The “Name” column of Table 1 may indicate a possible name (e.g., exemplary name that is in no way limiting) of each descriptor. the “Information Type” column of Table 1 may indicate a possible type of information that each descriptor may convey to the host system 105 (e.g., a flag being a binary indication, an attribute being a static parameter of the memory system 110, and a descriptor being a dynamic parameter of the memory system 110, where the information type for each descriptor may be merely exemplary and in no way limiting), and the “Read/Write” column of Table 1 may indicate an ability of the memory system 110, the host system 105, or both, to read, write (e.g., change), or both, each descriptor (e.g., which also may be exemplary and in no way limiting to each descriptor).

In some cases, fSwapCapable may indicate to the host system 105 that the memory system 110 is capable of supporting the swap partition operations as described herein (e.g., as further described with respect to the flowchart 200). qSwapMaxSize may indicate a threshold size (e.g., in megabytes (MB), in another measure of memory storage) of each swap partition 125, or for all of the swap partitions 125 of the memory system 110. For example, a size of a LUN of the memory system 110 configured with a swap partition may not exceed the value of qSwapMaxSize, or a combination of the size of each LUN configured with a swap partition may not exceed the value of qSwapMaxSize. bSwapChunkSize may indicate a size of one or more sub-partitions (e.g., chunks, a preferred chunk size in kilobytes (KB) or another measure of memory storage, 256 KB) for aligning swap write data into a swap partition of the memory system 110. For example, if a swap operation indicates swap data of a size equal to the bSwapChunkSize, the memory system 110 may perform the swap operations at an increased rate (e.g., relative to a swap operations indicating data of a different size).

Additionally, bSwapLU may indicate one or more LUNs of the memory system 110 that include a swap partition 125. In some cases, the one or more LUNs may be located within or across one or more memory device 130, or the descriptors may include multiple bSwapLU descriptors each indicating a LUN that includes a respective swap partition. If one or more bSwapLUs are set to an invalid LUN (e.g., a LUN not within the memory system 110), the swap partition functionality (e.g., as described herein) may be disabled within the memory system 110 (e.g., similar to fSwapCapable being false). qSwapStartLba may indicate a first (e.g., starting) LBA of a swap partition 125 in the memory system 110, where the qSwapStartLba may be at a memory location that aligns with (e.g., is a multiple of) bSwapChunkSize. qSwapEndLba may indicate a last (e.g., ending) LBA of the swap partition 125, where the qSwapEndLba may also align with bSwapChunkSize. In some cases, the descriptors may include a set of qSwapStartLba and qSwapEndLba for each swap partition 125 of the memory system 110, or each swap partition 125 may begin and end at qSwapStartLba and qSwapEndLba with respect to each associated LUN.

The memory system 110 may indicate one or more of the descriptors to the host system 105. For example, the host system 105 may transmit a request (e.g., a query, a read command) for one or more of the descriptors, and the memory system 110 may transmit a response indicating a value of the one or more of the descriptors. For each descriptor that may the host system 105 may be capable of writing (e.g., updating, descriptors that are not read only), the host system 105 may transmit a command indicating one or more of the descriptors and an updated value for each of the indicated one or more descriptors, and the memory system 110 may save the updated values for the one or more descriptors.

In some cases, the memory system 110 may detect (e.g., determine, identify) a type of one or more operations (e.g., or of data associated with the one or more operations) in accordance with the one or more descriptors. For example, if an operation (e.g., a write operation, a read operation) indicates data or a set of one or more LBAs that are within a swap partition 125, the memory system 110 may identify the data, the operation, or both, as swap traffic (e.g., as having a type that is associated with a swap partition 125, being a swap operation, indicating swap data). For example, the one or more LBAs associated with an operations may be within a range of LBAs indicated by qSwapStartLba and qSwapEndLba (e.g., and within a LUN indicated by bSwapLU), and thus the memory system 110 may detect that the data, the operation, or both, are swap traffic. Additionally, or alternatively, the memory system 110 may determine that traffic not associated with the one or more descriptors are not swap traffic.

In some cases, a swap partition 125 may be divided (e.g., split) into one or more sub-partitions (e.g., “swap chunks”), where each sub-partition may include a set of contiguous LBAs of the swap partition. For example, each sub-partition may have a size of the bSwapChunkSize, where a beginning of a first sub-partition of a swap partition 125 may be at a beginning of the swap partition 125, and each subsequent sub-partition of the swap partition 125 may begin directly after (e.g., without any LBAs between) a previous sub-partition (e.g., such that the sub-partitions align with the bSwapChunkSize in the swap partition 125).

In some cases, the memory system 110 (e.g., a memory system controller 115, a local controller 135) may maintain a plurality of pointers within one or more tables, where each pointer of the plurality of pointers may correspond to one or more sub-partitions of one or more swap partitions (e.g., each pointer addresses one sub-partition). In some cases, the one or more pointers may be referred to as a swap chunk table (SCT). In some cases, the memory system 110 may store at least a portion of the SCT (e.g., as much of the SCT as may fit) in local memory 120 (e.g., RAM, UFS ASIC SRAM). Additionally, or alternatively, if the memory system 110 determines that the local memory 120 does not have enough available memory to store all of the SCT, the memory system 110 (e.g., mNAND FW) may store (e.g., transfer from the local memory 120, page) a second portion of the SCT in one or more memory devices 130 (e.g., within NAND memory blocks). Accordingly, the memory system 110 may perform one or more swap operations (e.g., read operations, write operations) to a swap partition 125 according to info available in the SCT (e.g., plus an offset for misaligned contents as described herein).

The memory system 110 may update one or more portions of the SCT (e.g., in response to performing swap operations) within the local memory 120. During some synchronization events (e.g., the memory system 110 enters a low power mode), the memory system 110 may transfer (e.g., save) the SCT to a non-volatile memory device (e.g., a memory device 130, a NAND device), such that the SCT may be restored (e.g., back to the local memory 120) after the synchronization events.

Additionally, or alternatively, in some event (e.g., a power event (e.g., unplanned power loss), an error event) the memory system 110 may recover a portion of (e.g., or none of) the SCT. For example, and because one or more portions of the SCT may be stored in the local memory 120 (e.g., volatile memory), the memory system 110 may not attempt to recover at least the one or more portions of the SCT in such events. That is, the memory system 110 may refrain from storing at least a portion of the SCT in the memory devices 130 (e.g., non-volatile memory), and thus may not guarantee that the SCT after such an event is consistent with the SCT prior to the event.

In some cases, not attempting to recover the SCT (e.g., or associated data of the swap partitions 125) may allow the memory system 110 to operate the swap partitions with less latency. For example, some memory controllers (e.g., local controllers 135) may perform one or more data management procedures (e.g., changelog management, checkpoint management, data recovery procedures) as part of writing data (e.g., such as swap data) to a memory device 130, which may allow the memory system 110 to recover data in the memory devices 130 (e.g., as well as L2P table information) through, for example, a power event. However, the memory system 110 may skip (e.g., refrain from performing) the one or more data management procedures associated with in the SCT table (e.g., the plurality of pointers, and possibly the swap data written to the swap partition 125), as the SCT may be located in a local memory 120. For example, swap write traffic (e.g., the SCT, the swap data, both) may not be subject to any L2P management operations, checkpoint or changelog management operations, or recovery operations after a power loss (e.g., or other error events).

In some cases, the memory system 110 may manage (e.g., process, handle) swap traffic differently than other traffic. For example, the memory system 110 may determine whether one or more LBAs indicated by a swap operation are aligned with one or more sub-partitions of a swap partition. For example, a content of a swap operation (e.g., indicated data, the indicated LBAs) may align with one or more sub-partitions if a first LBA of the contents is the same as a first LBA of a first sub-partition, if a size of the contents is equal to a multiple of bSwapChunkSize, if a last LBA of the contents is the same as a last LBA of a second sub-partition (e.g., where the first sub-partition and the second sub-partition may be a same or different sub-partition), or any combination thereof.

If the memory system 110 determines that the contents of a swap operation are aligned with one or more sub-partitions of a swap partition 125, the memory system 110 may write the contents (e.g., data) of the swap operation directly (e.g., immediately, without other related and intervening operations) to the LBAs (e.g., the aligned one or more sub-partitions) of the swap partition 125. Additionally, one or more pointers of the SCT associated with the one or more aligned sub-partitions may be updated to indicate the written contents. If a portion of the SCT that includes the one or more pointers is not available in local memory 120 (e.g., within SRAM, the portion being stored in non-volatile memory in a memory device 130), the memory system 110 may load the portion of the SCT from non-volatile memory to the local memory 120 and update the one or more pointers (e.g., and transfer the portion back to the non-volatile memory after the update).

If the memory system 110 determines that the contents of the swap operation are not aligned with one or more sub-partitions of a swap partition, the memory system 110 (e.g., a local controller 135, a memory system controller 115) may perform other operations (e.g., a “read modify write” operation). For example, the misaligned contents (e.g., misaligned data, misaligned LBAs) of the swap operation may overlap with one or more sub-partitions of the swap partition. The memory system 110 may load one or more of the overlapped sub-partitions (e.g., one or more pages of data of the overlapped sub-partitions) from the swap partition to local memory 120 (e.g., SRAM), and may update the one or more overlapped sub-partitions in the local memory with a respective portion of the contents of the swap operation (e.g., write the contents of the swap operation to the one or more overlapped sub-portions). The memory system 110 may then write the one or more updated sub-portions (e.g., from the local memory 120) to the correct locations within the swap partition, and may update corresponding pointers in the SCT (e.g., as described with respect to writing the aligned contents). In some cases, the memory system 110 may perform one or more iterations of such operations for each overlapped sub-partition until all of the misaligned contents of the swap operation are written to the swap partition 125.

For some swap operations (e.g., read swap operations), the memory system 110 may utilize an offset to determine a starting LBA of contents of the swap operation. For example, the memory system 110 may determine a sub-partition of a swap partition 125 associated with the contents of a swap operation according to the LBAs indicated by the swap operation and the pointers of the SCT. Additionally, the memory system may determine an offset (e.g., indicated by the swap operation, determined by the memory system 110 using a starting LBA of the swap operation and the pointer of the SCT). The memory system 110 may then perform a swap read from the swap partition using the pointer from the SCT and the offset.

In some cases, the memory system 110 may implement one or more techniques to decrease a latency associated with operating the swap partitions 125. For example, the memory system 110 may allocate one or more LBAs within a single level cell (SLC) block (e.g., as opposed to multi-level cell blocks) within an LU (e.g., according to SLC block availability) to be a swap partition (e.g., via bSwapLU, qSwapStartLba, and qSwapEndLba, as described herein with respect to Table 1) to reduce a latency for swap reads and swap writes to the swap partition. Additionally, or alternatively, the memory system 110 may prioritize swap traffic over one or more other types of traffic (e.g., write booster traffic) regarding the SLC blocks. For example, the memory system 110 may allocate one or more SLC blocks that were used for write booster mode traffic to be a swap partition.

In the following description of flowchart 200, the operations may be performed in a different order than the order shown, or other operations may be added or removed from the flowchart 200. For example, some operations may also be left out of flowchart 200, may be performed in different orders or at different times, or other operations may be added to flowchart 200. Although the memory system 110 is describes as performing the operations of flowchart 200, some aspects of some operations may also be performed by one or more other wireless devices or network devices. Additionally, each operation of the flowchart 200 may be implemented in instructions or firmware stored on memory of a memory system 110 (e.g., a memory device 130, local memory 120-b) or of a host system 105 (e.g., the local memory 120-a) and executed by the memory system controller 115, a local controller 135, or a combination thereof. Additionally, or alternatively, aspects of the flowchart 200 may be implemented as instructions stored in one or more memories (e.g., firmware stored in one or more memories coupled with a memory system 110). For example, the instructions, when executed by one or more controllers (e.g., the memory system controller 115, a local controller 135), may cause the one or more controllers (e.g., or a device or a system) to perform the operations of the flowchart 200.

At 205, one or more descriptors (e.g., swap partition descriptors, such as the descriptors described herein with respect to Table 1) may be updated. For example, a host system 105 may update the one or more descriptors at the memory system 110. The memory system 110 may store (e.g., in one or more memory locations accessible to the host system 105) the one or more descriptors associated with one or more partitions (e.g., swap partitions 125) of the memory system 110. For example, the one or more descriptors may indicate one or more of a capability of the memory system to support the one or more partitions (e.g., as well as a plurality of pointers as described herein and at 230), a threshold size of the partition, a size for each of a plurality of sub-partitions within the partition, a LUN of the memory system associated with the partition, a beginning LBA of the partition, an ending LBA of the partition, or any combination thereof. In some cases, the memory system 110 may receive, from the host system 105, one or more commands to update one or more of the descriptors, including the LUN of the memory system 110 associated with the partition, the beginning LBA of the partition, the ending LBA of the partition, or any combination thereof.

At 210, a swap data write command may be received. For example, the memory system 110 may receive (e.g., via a memory system controller 115) a write command from the host system 105, where the write command may indicate data, LBAs, or both, associated with swap operations. Thus, the memory system 110 may receive a command to write data (e.g., swap data) to the memory system 110, where the command may indicate one or more physical addresses (e.g., physical block addresses (PBAs)) associated with the data, which may correspond to one or more LBAs (e.g., via an L2P table, via the plurality of pointers described herein and at 230).

At 215, a swap data type (e.g., swap traffic) may be detected. For example, the memory system 110 may detect a data type of the data associated with the received command to be associated with a swap partition (e.g., a swap partition 125) within the memory system 110. In some cases, the memory system 110 may detect a type of the data according to whether the one or more LBAs associated with the data are within a range of LBAs associated with the partition (e.g., the swap partition 125, of one or more partitions (e.g., swap partitions 125) of the memory system 110). In some cases, the one or more partitions of the memory system may be for storing data associated with one or more volatile memory operations (e.g., swap data). In some cases, the partition may include a set of LBAs mapped to a set of PBAs of the memory system 110, and the set of PBAs may be associated with storing one bit per memory cell. Additionally, or alternatively, the memory system 110 may utilize the partition as a virtual random access space (e.g., RAM, local memory 120) for the host system 105 (e.g., which is coupled with the memory system 110).

At 220, an alignment of the data of the command may be determined. For example, the memory system 110 (e.g., the memory system controller 115, a local controller 135) may determining, in response to the type of the data being associated with the partition, whether the one or more LBAs associated with the data align with one or more of a plurality of sub-partitions of the partition. For example, the memory system 110 may determine whether a first LBA of the one or more LBAs is a first LBA of a first sub-partition, whether a size of the data is a multiple of a size that is common to each of the plurality of sub-partitions, or both.

At 225, data may be written to a partition (e.g., a swap partition). For example, the memory system 110 (e.g., the memory system controller 115, a local controller 135) may write the data to the partition. In some cases, the memory system 110 may write the data to the partition (e.g., and to the one or more LBAs associated with the data) in accordance with whether the one or more LBAs align with one or more of the plurality of sub-partitions. For example, the memory system 110 may either perform the actions of 227 or 228 in accordance with whether the one or more LBAs align with one or more sub-partitions or do not align with one or more sub-partitions, respectively.

At 227, if the memory system 110 determines that the data (e.g., swap data) aligns with the sub-partitions as described herein, the data may be directly written to one or more sub-partitions (e.g., and to one or more LBAs). For example, the memory system 110 (e.g., the memory system controller 115, a local controller 135) may write the data directly to the one or more sub-partitions in response to determining that the one or more LBAs aligning with the one or more sub-partitions (e.g., as described herein with respect to FIG. 2).

At 228, if the memory system 110 determines that the data (e.g., swap data) does not align with the sub-partitions as described herein, one or more other operations (e.g., other techniques for writing data to one or more sub-partitions) may be performed (e.g., including the “read modify write” operation described herein with respect to FIG. 2) For example, the memory system 110 (e.g., the memory system controller 115, a local controller 135) may read second data from at least one sub-partition that includes at least a portion of the one or more LBAs associated with the data in response to determining that the one or more LBAs do not align with one or more sub-partitions of the plurality of sub-partitions of a partition. The memory system 110 may update the second data to include at least a portion of the data associated with the portion of the one or more LBAs in response to reading the at least one sub-partition, and may write the second data (e.g., updated with the portion of the data) back to the at least one sub-partition.

At 230, one or more pointers of a plurality of pointers (e.g., the SCT as described herein with respect to FIG. 2) may be updated in response to writing the data at 225. For example, the memory system 110 (e.g., the memory system controller 115, a local controller 135) may update the one or more pointers in response to writing the data, where each sub-partition of the plurality of sub-partitions may be associated with a corresponding pointer of the plurality of pointers, and each of the one or more pointers corresponds to an updated sub-partition. In some cases, the memory system 110 may store at least a first subset of pointers of the plurality of pointers (e.g., if not all of the plurality of pointers) in RAM for a memory controller (e.g., within the local memory 120) within the memory system 110, and the memory system 110 may update the plurality of pointers after the first subset of pointers has been stored in the RAM for the memory controller. Additionally, or alternatively, the memory system 110 may store a second subset of pointers of the plurality of pointers in non-volatile memory of the memory system (e.g., within one or more memory device 130) after the first subset of pointers of the plurality of pointers has been stored in the RAM of the memory system. For example, the memory system 110 may determine that the RAM does not have memory space to store the second subset of the plurality of pointers, and may store the second subset of the plurality of pointers in the non-volatile memory accordingly.

In the cases (e.g., such as after a power event, a data error event, a data loss event), the memory system 110 may refrain from recovering at least the first subset of the plurality of pointers (e.g., the subset stored in the local memory 120 (e.g., SRAM)). For example, the memory system 110 may refrain from recovering the pointers in response to the plurality of pointers being associated with the partition, in response to the plurality of pointers being stored in the local memory 120, or both.

At 235, a read command may be received. For example, the memory system 110 (e.g., the memory system controller 115, a memory system controller 115) may receive a read command to read second data, where the second data may be associated with one or more second LBAs of the partition. That is, the memory system 110 may determine that a type of a data indicated to be read by the read command may be associated with a partition of the one or more partitions (e.g., swap partitions, the read command is swap traffic).

At 240, the second data may be read from the partition. For example, the memory system 110 (e.g., the memory system controller 115, a local controller 135) may reading the second data from the partition in response to receiving the read command at 235. In some cases, the memory system 110 may read the second data using one or more of the plurality of pointers, an offset (e.g., indicated by the read command, determined by the memory system 110 as described herein) from a beginning LBA of a sub-partition (e.g., as indicted by the one or more of the plurality of pointers), or both.

Accordingly, the memory system 110 may implement a swap partition 125. Such techniques may allow the memory system 110 to save storage space at a local memory 120 using swap operations, while decreasing latency and increasing throughput associated with the swap operations.

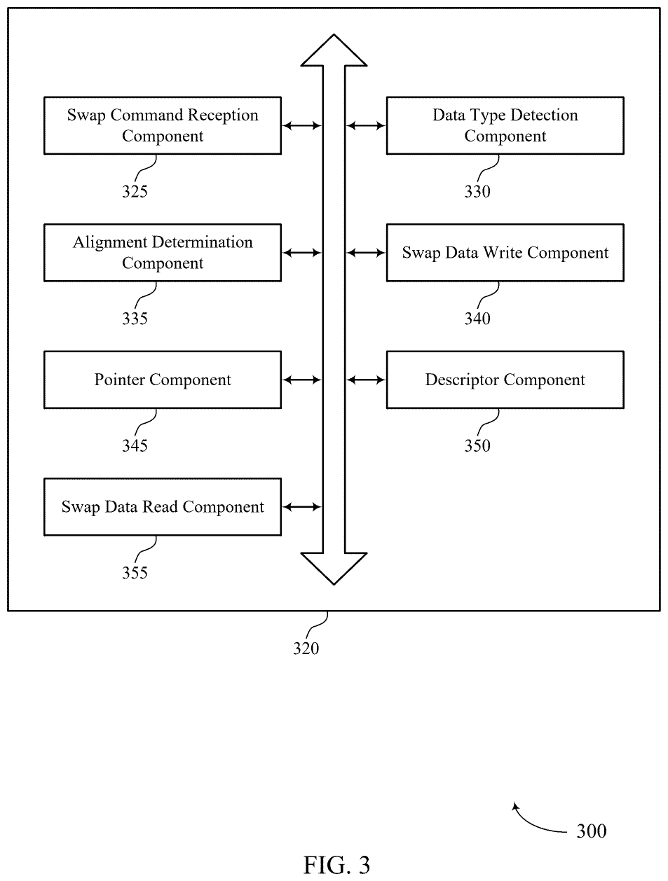

FIG. 3 shows a block diagram 300 of a memory system 320 that supports a low latency partition for memory swap operations in accordance with examples as disclosed herein. The memory system 320 may be an example of aspects of a memory system as described with reference to FIGS. 1 through 2. The memory system 320, or various components thereof, may be an example of means for performing various aspects of a low latency partition for memory swap operations as described herein. For example, the memory system 320 may include a swap command reception component 325, a data type detection component 330, an alignment determination component 335, a swap data write component 340, a pointer component 345, a descriptor component 350, a swap data read component 355, or any combination thereof. Each of these components, or components of subcomponents thereof (e.g., one or more processors, one or more memories), may communicate, directly or indirectly, with one another (e.g., via one or more buses).

The memory system 320 may support memory operations in accordance with examples as disclosed herein. The swap command reception component 325 may be configured as or otherwise support a means for receiving a command to write data to a memory system, where the data is associated with one or more logical addresses. The data type detection component 330 may be configured as or otherwise support a means for detecting a type of the data in accordance with whether the one or more logical addresses are within a range of logical addresses associated with a partition of one or more partitions of the memory system, the one or more partitions of the memory system for storing data associated with one or more volatile memory operations. The alignment determination component 335 may be configured as or otherwise support a means for determining, in response to the type of the data being associated with the partition, whether the one or more logical addresses align with one or more of a plurality of sub-partitions of the partition. The swap data write component 340 may be configured as or otherwise support a means for writing the data to the one or more logical addresses in accordance with whether the one or more logical addresses align with one or more sub-partitions of the plurality of sub-partitions. The pointer component 345 may be configured as or otherwise support a means for updating one or more pointers of a plurality of pointers in response to writing the data, where each sub-partition of the plurality of sub-partitions is associated with a corresponding pointer of the plurality of pointers.

In some examples, to support writing the data to the one or more logical addresses, the swap data write component 340 may be configured as or otherwise support a means for writing the data directly to the one or more logical addresses in the one or more sub-partitions of the plurality of sub-partitions in response to determining that the one or more logical addresses align with the one or more sub-partitions.

In some examples, to support writing the data to the one or more logical addresses, the swap data write component 340 may be configured as or otherwise support a means for reading second data from a sub-partition that includes at least a portion of the one or more logical addresses in response to determining that the one or more logical addresses do not align with the one or more sub-partitions of the plurality of sub-partitions. In some examples, to support writing the data to the one or more logical addresses, the swap data write component 340 may be configured as or otherwise support a means for updating the second data to include at least a portion of the data associated with the portion of the one or more logical addresses. In some examples, to support writing the data to the one or more logical addresses, the swap data write component 340 may be configured as or otherwise support a means for writing the second data to the sub-partition.

In some examples, the descriptor component 350 may be configured as or otherwise support a means for storing, in one or more memory locations accessible to a host system, one or more descriptors associated with the partition of the memory system, where the one or more descriptors indicate one or more of a capability of the memory system to support the partition and the plurality of pointers, a threshold size of the partition, a size for each of the plurality of sub-partitions, a logical unit of the memory system associated with the partition, a beginning logical address of the partition, an ending logical address of the partition, or any combination thereof.

In some examples, the descriptor component 350 may be configured as or otherwise support a means for receiving, from the host system, one or more commands to update the logical unit of the memory system associated with the partition, update the beginning logical address of the partition, update the ending logical address of the partition, or any combination thereof.

In some examples, the swap command reception component 325 may be configured as or otherwise support a means for receiving a read command to read second data, where the second data is associated with one or more second logical addresses of the partition. In some examples, the swap data read component 355 may be configured as or otherwise support a means for reading the second data using the plurality of pointers, an offset from a beginning logical address of a sub-partition, or both.

In some examples, the pointer component 345 may be configured as or otherwise support a means for storing a first subset of pointers of the plurality of pointers in random access memory for a memory controller within the memory system.

In some examples, the pointer component 345 may be configured as or otherwise support a means for storing a second subset of pointers of the plurality of pointers in non-volatile memory of the memory system after the first subset of pointers of the plurality of pointers has been stored in the random access memory for the memory controller.

In some examples, the partition includes a set of logical addresses mapped to a set of physical addresses of the memory system. In some examples, the set of physical addresses are associated with storing one bit per memory cell.

In some examples, the pointer component 345 may be configured as or otherwise support a means for refraining from storing the plurality of pointers to non-volatile memory within the memory system.

In some examples, the pointer component 345 may be configured as or otherwise support a means for refraining, after a power event for the memory system, from recovering the plurality of pointers in accordance with the plurality of pointers being associated with the partition.

In some examples, to support determining whether the one or more logical addresses align with the one or more sub-partitions of the plurality of sub-partitions, the alignment determination component 335 may be configured as or otherwise support a means for determining whether a first logical address of the one or more logical addresses is a first logical address of a first sub-partition, whether a size of the data is a multiple of a size that is common to each of the plurality of sub-partitions, or both.

In some examples, the partition includes a virtual random access space for a host system associated with the memory system.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

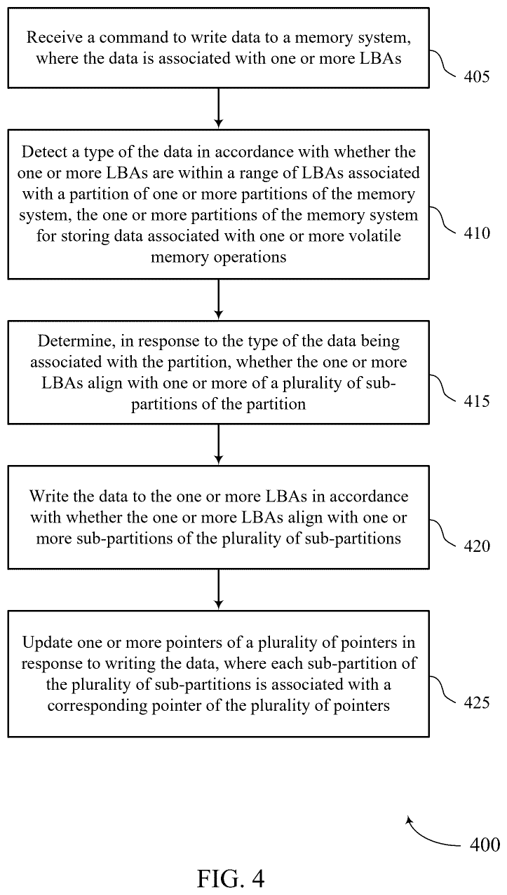

FIG. 4 shows a flowchart illustrating a method 400 that supports a low latency partition for memory swap operations in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include receiving a command to write data to a memory system, where the data is associated with one or more logical addresses. In some examples, aspects of the operations of 405 may be performed by a swap command reception component 325 as described with reference to FIG. 3.

At 410, the method may include detecting a type of the data in accordance with whether the one or more logical addresses are within a range of logical addresses associated with a partition of one or more partitions of the memory system, the one or more partitions of the memory system for storing data associated with one or more volatile memory operations. In some examples, aspects of the operations of 410 may be performed by a data type detection component 330 as described with reference to FIG. 3.

At 415, the method may include determining, in response to the type of the data being associated with the partition, whether the one or more logical addresses align with one or more of a plurality of sub-partitions of the partition. In some examples, aspects of the operations of 415 may be performed by an alignment determination component 335 as described with reference to FIG. 3.

At 420, the method may include writing the data to the one or more logical addresses in accordance with whether the one or more logical addresses align with one or more sub-partitions of the plurality of sub-partitions. In some examples, aspects of the operations of 420 may be performed by a swap data write component 340 as described with reference to FIG. 3.

At 425, the method may include updating one or more pointers of a plurality of pointers in response to writing the data, where each sub-partition of the plurality of sub-partitions is associated with a corresponding pointer of the plurality of pointers. In some examples, aspects of the operations of 425 may be performed by a pointer component 345 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a command to write data to a memory system, where the data is associated with one or more logical addresses; detecting a type of the data in accordance with whether the one or more logical addresses are within a range of logical addresses associated with a partition of one or more partitions of the memory system, the one or more partitions of the memory system for storing data associated with one or more volatile memory operations; determining, in response to the type of the data being associated with the partition, whether the one or more logical addresses align with one or more of a plurality of sub-partitions of the partition; writing the data to the one or more logical addresses in accordance with whether the one or more logical addresses align with one or more sub-partitions of the plurality of sub-partitions; and updating one or more pointers of a plurality of pointers in response to writing the data, where each sub-partition of the plurality of sub-partitions is associated with a corresponding pointer of the plurality of pointers.

Aspect 2: The method, apparatus, or non-transitory computer-readable medium of aspect 1, where operations, features, circuitry, logic, means, or instructions, or any combination thereof for writing the data to the one or more logical addresses includes operations, features, circuitry, logic, means, or instructions, or any combination thereof for writing the data directly to the one or more logical addresses in the one or more sub-partitions of the plurality of sub-partitions in response to determining that the one or more logical addresses align with the one or more sub-partitions.

Aspect 3: The method, apparatus, or non-transitory computer-readable medium of any of aspects 1 through 2, where operations, features, circuitry, logic, means, or instructions, or any combination thereof for writing the data to the one or more logical addresses includes operations, features, circuitry, logic, means, or instructions, or any combination thereof for reading second data from a sub-partition that includes at least a portion of the one or more logical addresses in response to determining that the one or more logical addresses do not align with the one or more sub-partitions of the plurality of sub-partitions; updating the second data to include at least a portion of the data associated with the portion of the one or more logical addresses; and writing the second data to the sub-partition.

Aspect 4: The method, apparatus, or non-transitory computer-readable medium of any of aspects 1 through 3, further including operations, features, circuitry, logic, means, or instructions, or any combination thereof for storing, in one or more memory locations accessible to a host system, one or more descriptors associated with the partition of the memory system, where the one or more descriptors indicate one or more of a capability of the memory system to support the partition and the plurality of pointers, a threshold size of the partition, a size for each of the plurality of sub-partitions, a logical unit of the memory system associated with the partition, a beginning logical address of the partition, an ending logical address of the partition, or any combination thereof.

Aspect 5: The method, apparatus, or non-transitory computer-readable medium of aspect 4, further including operations, features, circuitry, logic, means, or instructions, or any combination thereof for receiving, from the host system, one or more commands to update the logical unit of the memory system associated with the partition, update the beginning logical address of the partition, update the ending logical address of the partition, or any combination thereof.

Aspect 6: The method, apparatus, or non-transitory computer-readable medium of any of aspects 1 through 5, further including operations, features, circuitry, logic, means, or instructions, or any combination thereof for receiving a read command to read second data, where the second data is associated with one or more second logical addresses of the partition and reading the second data using the plurality of pointers, an offset from a beginning logical address of a sub-partition, or both.

Aspect 7: The method, apparatus, or non-transitory computer-readable medium of any of aspects 1 through 6, further including operations, features, circuitry, logic, means, or instructions, or any combination thereof for storing a first subset of pointers of the plurality of pointers in random access memory for a memory controller within the memory system.

Aspect 8: The method, apparatus, or non-transitory computer-readable medium of aspect 7, further including operations, features, circuitry, logic, means, or instructions, or any combination thereof for storing a second subset of pointers of the plurality of pointers in non-volatile memory of the memory system after the first subset of pointers of the plurality of pointers has been stored in the random access memory for the memory controller.

Aspect 9: The method, apparatus, or non-transitory computer-readable medium of any of aspects 1 through 8, where the partition includes a set of logical addresses mapped to a set of physical addresses of the memory system and the set of physical addresses are associated with storing one bit per memory cell.

Aspect 10: The method, apparatus, or non-transitory computer-readable medium of any of aspects 1 through 9, further including operations, features, circuitry, logic, means, or instructions, or any combination thereof for refraining from storing the plurality of pointers to non-volatile memory within the memory system.

Aspect 11: The method, apparatus, or non-transitory computer-readable medium of any of aspects 1 through 10, further including operations, features, circuitry, logic, means, or instructions, or any combination thereof for refraining, after a power event for the memory system, from recovering the plurality of pointers in accordance with the plurality of pointers being associated with the partition.

Aspect 12: The method, apparatus, or non-transitory computer-readable medium of any of aspects 1 through 11, where operations, features, circuitry, logic, means, or instructions, or any combination thereof for determining whether the one or more logical addresses align with the one or more sub-partitions of the plurality of sub-partitions includes operations, features, circuitry, logic, means, or instructions, or any combination thereof for determining whether a first logical address of the one or more logical addresses is a first logical address of a first sub-partition, whether a size of the data is a multiple of a size that is common to each of the plurality of sub-partitions, or both.

Aspect 13: The method, apparatus, or non-transitory computer-readable medium of any of aspects 1 through 12, where the partition includes a virtual random access space for a host system associated with the memory system.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for memory operations, comprising:
processing circuitry associated with one or more memory devices and configured to cause the apparatus to:
receive a command to write data to a memory system, wherein the data is associated with one or more logical addresses;
detect a type of the data in accordance with whether the one or more logical addresses are within a range of logical addresses associated with a partition of one or more partitions of the memory system, the one or more partitions of the memory system for storing data associated with one or more volatile memory operations;
determine, in response to the type of the data being associated with the partition, whether the one or more logical addresses align with one or more of a plurality of sub-partitions of the partition;
write the data to the one or more logical addresses in accordance with whether the one or more logical addresses align with one or more sub-partitions of the plurality of sub-partitions; and
update one or more pointers of a plurality of pointers in response to writing the data, wherein each sub-partition of the plurality of sub-partitions is associated with a corresponding pointer of the plurality of pointers.

2. The apparatus of claim 1, wherein, to write the data to the one or more logical addresses, the processing circuitry is configured to cause the apparatus to:
write the data directly to the one or more logical addresses in the one or more sub-partitions of the plurality of sub-partitions in response to determining that the one or more logical addresses align with the one or more sub-partitions.

3. The apparatus of claim 1, wherein, to write the data to the one or more logical addresses, the processing circuitry is configured to cause the apparatus to:
read second data from a sub-partition that comprises at least a portion of the one or more logical addresses in response to determining that the one or more logical addresses do not align with the one or more sub-partitions of the plurality of sub-partitions;
update the second data to include at least a portion of the data associated with the portion of the one or more logical addresses; and
write the second data to the sub-partition.

4. The apparatus of claim 1, wherein the processing circuitry is further configured to cause the apparatus to:
store, in one or more memory locations accessible to a host system, one or more descriptors associated with the partition of the memory system, wherein the one or more descriptors indicate one or more of a capability of the memory system to support the partition and the plurality of pointers, a threshold size of the partition, a size for each of the plurality of sub-partitions, a logical unit of the memory system associated with the partition, a beginning logical address of the partition, an ending logical address of the partition, or any combination thereof.

5. The apparatus of claim 4, wherein the processing circuitry is further configured to cause the apparatus to:
receive, from the host system, one or more commands to update the logical unit of the memory system associated with the partition, update the beginning logical address of the partition, update the ending logical address of the partition, or any combination thereof.

6. The apparatus of claim 1, wherein the processing circuitry is further configured to cause the apparatus to:
receive a read command to read second data, wherein the second data is associated with one or more second logical addresses of the partition; and
read the second data using the plurality of pointers, an offset from a beginning logical address of a sub-partition, or both.

7. The apparatus of claim 1, wherein the processing circuitry is further configured to cause the apparatus to:
store a first subset of pointers of the plurality of pointers in random access memory for a memory controller within the memory system.

8. The apparatus of claim 7, wherein the processing circuitry is further configured to cause the apparatus to:
store a second subset of pointers of the plurality of pointers in non-volatile memory of the memory system after the first subset of pointers of the plurality of pointers have been stored in the random access memory for the memory controller.

9. The apparatus of claim 1, wherein:
the partition comprises a set of logical addresses mapped to a set of physical addresses of the memory system, and
the set of physical addresses are associated with storing one bit per memory cell.

10. The apparatus of claim 1, wherein the processing circuitry is further configured to cause the apparatus to:
refrain from storing the plurality of pointers to non-volatile memory within the memory system.

11. The apparatus of claim 1, wherein the processing circuitry is further configured to cause the apparatus to:
refrain, after a power event for the memory system, from recovering the plurality of pointers in accordance with the plurality of pointers being associated with the partition.

12. The apparatus of claim 1, wherein, to determine whether the one or more logical addresses align with the one or more sub-partitions of the plurality of sub-partitions, the processing circuitry is configured to cause the apparatus to:
determine whether a first logical address of the one or more logical addresses is a first logical address of a first sub-partition, whether a size of the data is a multiple of a size that is common to each of the plurality of sub-partitions, or both.

13. The apparatus of claim 1, wherein the partition comprises a virtual random access space for a host system associated with the memory system.

14. A non-transitory computer-readable medium storing code for memory operations, the code comprising instructions executable by one or more processors to:
receive a command to write data to a memory system, wherein the data is associated with one or more logical addresses;
detect a type of the data in accordance with whether the one or more logical addresses are within a range of logical addresses associated with a partition of one or more partitions of the memory system, the one or more partitions of the memory system for storing data associated with one or more volatile memory operations;
determine, in response to the type of the data being associated with the partition, whether the one or more logical addresses align with one or more of a plurality of sub-partitions of the partition;
write the data to the one or more logical addresses in accordance with whether the one or more logical addresses align with one or more sub-partitions of the plurality of sub-partitions; and
update one or more pointers of a plurality of pointers in response to writing the data, wherein each sub-partition of the plurality of sub-partitions is associated with a corresponding pointer of the plurality of pointers.

15. The non-transitory computer-readable medium of claim 14, wherein, to write the data to the one or more logical addresses, the instructions, when executed by the one or more processors of the memory system, cause the memory system to:
write the data directly to the one or more logical addresses in the one or more sub-partitions of the plurality of sub-partitions in response to determining that the one or more logical addresses align with the one or more sub-partitions.

16. The non-transitory computer-readable medium of claim 14, wherein, to write the data to the one or more logical addresses, the instructions, when executed by the one or more processors of the memory system, cause the memory system to:
read second data from a sub-partition that comprises at least a portion of the one or more logical addresses in response to determining that the one or more logical addresses do not align with the one or more sub-partitions of the plurality of sub-partitions;
update the second data to include at least a portion of the data associated with the portion of the one or more logical addresses; and
write the second data to the sub-partition.

17. The non-transitory computer-readable medium of claim 14, wherein the instructions, when executed by the one or more processors of the memory system, further cause the memory system to:
store, in one or more memory locations accessible to a host system, one or more descriptors associated with the partition of the memory system, wherein the one or more descriptors indicate one or more of a capability of the memory system to support the partition and the plurality of pointers, a threshold size of the partition, a size for each of the plurality of sub-partitions, a logical unit of the memory system associated with the partition, a beginning logical address of the partition, an ending logical address of the partition, or any combination thereof.

18. The non-transitory computer-readable medium of claim 17, wherein the instructions, when executed by the one or more processors of the memory system, further cause the memory system to:
receive, from the host system, one or more commands to update the logical unit of the memory system associated with the partition, update the beginning logical address of the partition, update the ending logical address of the partition, or any combination thereof.

19. The non-transitory computer-readable medium of claim 14, wherein the instructions, when executed by the one or more processors of the memory system, further cause the memory system to:
receive a read command to read second data, wherein the second data is associated with one or more second logical addresses of the partition; and
read the second data using the plurality of pointers, an offset from a beginning logical address of a sub-partition, or both.

20. The non-transitory computer-readable medium of claim 14, wherein the instructions, when executed by the one or more processors of the memory system, further cause the memory system to:
store a first subset of pointers of the plurality of pointers in random access memory for a memory controller within the memory system.

21. The non-transitory computer-readable medium of claim 20, wherein the instructions, when executed by the one or more processors of the memory system, further cause the memory system to:
store a second subset of pointers of the plurality of pointers in non-volatile memory of the memory system after the first subset of pointers of the plurality of pointers has been stored in the random access memory for the memory controller.

22. The non-transitory computer-readable medium of claim 14, wherein:
the partition comprises a set of logical addresses mapped to a set of physical addresses of the memory system, and
the set of physical addresses are associated with storing one bit per memory cell.

23. A method for memory operations, comprising:
receiving a command to write data to a memory system, wherein the data is associated with one or more logical addresses;
detecting a type of the data in accordance with whether the one or more logical addresses are within a range of logical addresses associated with a partition of one or more partitions of the memory system, the one or more partitions of the memory system for storing data associated with one or more volatile memory operations;
determining, in response to the type of the data being associated with the partition, whether the one or more logical addresses align with one or more of a plurality of sub-partitions of the partition;
writing the data to the one or more logical addresses in accordance with whether the one or more logical addresses align with one or more sub-partitions of the plurality of sub-partitions; and
updating one or more pointers of a plurality of pointers in response to writing the data, wherein each sub-partition of the plurality of sub-partitions is associated with a corresponding pointer of the plurality of pointers.
